(19) United States
(12) Patent Application Publication
(10) Pub. No.: US 2006/0179215 A1
(43) Pub. Date: Aug. 10, 2006

(54) Apparatus for detecting disk write omissions

(75) Inventors: Shinya Mochizuki, Kawasaki (JP); Hideo Takahashi, Kawasaki (JP); Mikio Ito, Kawasaki (JP); Hidejiro Daikokuya, Kawasaki (JP); Kazuhiko Ikeuchi, Kawasaki (JP); Hideki Yamanaka, Kawasaki (JP); Katsuhiko Nagashima, Kawasaki (JP); Akihito Kobayashi, Kawasaki (JP); Koji Uchida, Kawasaki (JP); Shinichi Nishizono, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/131,416

(22) Filed: May 18, 2005

(30) Foreign Application Priority Data
Feb. 8, 2005 (JP) 2005-31232

(51) Int. Cl. G06F 12/00

(52) U.S. Cl. 711/112; 711/170

(57) ABSTRACT

In the present invention, for each set of blocks [#(0) to #(N−1)] storing update data, a history block [#(N)] storing an update state value, for example, a generation, time or check code, showing an update state is provided, constituting a set of management data as a check object. When writing update data on a disk, a new update state value is calculated for the same set of management data and stored in memory as update state confirmation value. The new update state value is also set as write data in the history block in the same set of management data, and the entire of the set of management data including update data and update state value are written onto a disk. The history block is read and disk write omissions are detected by comparing the update state value and the update state confirmation value stored in memory.

### CROSS-REFERENCE TO RELATED APPLICATIONS

This application claims the conventional priority based on Japanese Application No. 2005-031232, filed on Feb. 8, 2005, the disclosures of which are incorporated herein by reference.

### BACKGROUND OF THE INVENTION

1. Field of the Invention

The present invention relates to technology that checks data that was written on a disk, and more particularly to an apparatus and method for detecting disk write omissions that accurately detect write omissions on a disk.

2. Description of the Related Art

Conventionally, when checking data to ensure that the data is written on a disk, a check code is established for each block that is an I/O (Input/Output) unit to the disk, and this check code is used to ensure that the data is written accurately.

FIG. 19 illustrates an example of the format of one block. In the format example shown in FIG. 19, 8 bytes containing a BCC (Block Check Code) as a check code to detect errors is added to data of 512 bytes, to form 1 block of 520 bytes.

In this connection, Japanese Patent Laid-Open No. 10-171608 discloses a magnetic disc array and a data checking method used in a magnetic disc array.

When updating data on a disk in accordance with a data write request from a host computer, in some cases an area for which writing was requested is not actually updated.

Here, the term “disk write omission” refers to a case in which updating was not actually performed for a particular area and the old data remains as it was in that area even though the disk returns a reply to the effect that the area for which writing was requested was updated with the new data in response to a data write request from the host computer.

When a disk write omission occurs in one part of one block, for example, as in a case in which the first 4 bytes of the 512 bytes of data within the one block shown in FIG. 19 was not updated, the relation between the BCC and the data breaks down. Accordingly, in this case, a disk write omission can be detected by the conventional technology that conducts a data check using the BCC.

However, when a disk write omission occurs for the entire area of the one block the old data will remain in the entire area of the one block of FIG. 19. In this case, the relation between the BCC and the data is maintained as the old one block. Accordingly, there is a problem that this disk write omission cannot be detected by the conventional technology that conducts a data check using the BCC.

Further, an object of the technology disclosed in the Japanese Patent Laid-Open No. 10-171608 is to detect in which data read from which address of which magnetic disk unit among a plurality of magnetic disk units an error exists, and it does not attempt to accurately detect a disk write omission that occurred in the entire area of one block.

### SUMMARY OF THE INVENTION

An object of the present invention is to provide an apparatus and method for detecting disk write omissions that solve the aforementioned problem of the prior art by enabling accurate detection of disk write omissions, even when a disk write omission occurred in the entire area of one block.

The present invention provides an apparatus for detecting write omissions on a disk which stores electronic data as an object for processing in a computer. The apparatus comprises an update state setting unit relating a history block to a set of blocks, the history block being set an update state value indicating an update state, the set of blocks being set an update data as an object of reading and writing by the computer, making a set of management data to be an object of an update state check from the set of blocks and the history block, generating a new update state value which is different to an update state value before updating when writing the update data on the disk, storing the new update state value in a memory as an update state confirmation value, writing the set of management data containing the update data and the new update state value on the disk, and an update state checking unit comparing the update state value in the set of management data read from the disk with the update state confirmation value which is stored in the memory, and detecting that a disk write omission occurred when the update state value and the update state confirmation value do not match.

Preferably, in the aforementioned apparatus for detecting disk write omissions, the update state value comprises an update generation number, an update time, or a check code which is uniquely generated from the update data of the set of blocks, or a combination thereof.

According to the present invention, disk write omissions can be accurately detected even when a disk write omission occurred in the entire area of the set of management data.

The present invention also provides an apparatus for detecting write omissions on a disk which stores electronic data as an object for processing in a computer. The apparatus comprises an update state setting unit relating a history block to a set of blocks, the history block being set an update state value indicating an update state, the set of blocks being set an update data as an object of reading and writing by the computer, making a set of management data to be an object of an update state check from the set of blocks and the history block, calculating a first update state value that is defined according to the update data in the set of management data when writing the update data on the disk, writing the set of management data including the update data and the first update state value on the disk, and an update state checking unit calculating a second update state value defined according to the update data in the set of management data read from the disk, setting the second update state value as an update state confirmation value, comparing the first update state value in the set of management data read from the disk with the update state confirmation value, and detecting that a disk write omission occurred when the first update value and the update state confirmation value do not match.

The present invention detects a disk write omission by comparing an update state value read from a disk with an update state confirmation value that was calculated from data read from the disk. Thus, according to the present invention, it is possible to detect a disk write omission even without previously storing an update state confirmation value in an apparatus for detecting disk write omissions.

The present invention further provides an apparatus for detecting write omissions on a plurality of disks which store electronic data as an object for processing in a computer. The apparatus comprises an update state setting unit relating a history block to a set of blocks, the history block being set an update state value indicating an update state, the set of blocks being set an update data as an object of reading and writing by the computer, making a set of management data to be an object of an update state check from the set of blocks and the history block, generating a new update state value which is different to an update state value before updating when writing the update data on the plurality of disks, and writing the set of management data containing the update data and the new update state value on the plurality of disks redundantly, and an update state checking unit comparing the update state values in the set of management data which are read from each of the plurality of disks, and detecting that a disk write omission occurred when the update state values do not match each other.

The present invention detects disk write omissions by comparing update state values read from a plurality of disks, respectively. Thus, according to the present invention, a disk write omission that occurred in the entire area of the set of management data can be detected even without previously storing an update state confirmation value in the apparatus for detecting disk write omissions.

Preferably, in the present invention, the update state setting unit further comprises a data merging unit. When a block which is not an object of updating is present between the history block and the blocks containing update data whose contents are changed in the current operation in the set of management data, the data merging unit reads data of the block which is not an object of updating from the disk and merges the read data with the data of the blocks containing the update data.

According to the present invention, writing to a disk of blocks in which update data is set and a block in which an update state value is set can be conducted in one write process.

The present invention provides a method for detecting write omissions on a disk which stores electronic data as an object for processing in a computer. The method comprises relating a history block to a set of blocks, the history block being set an update state value indicating an update state, the set of blocks being set an update data as an object of reading and writing by the computer, making a set of management data to be an object of an update state check from the set of blocks and the history block, generating a new update state value which is different to an update state value before updating when writing the update data on the disk, storing the new update state value in a memory as an update state confirmation value, writing the set of management data containing the update data and the new update state value on the disk, comparing the update state value in the set of management data read from the disk with the update state confirmation value which is stored in the memory, and detecting that a disk write omission occurred when the update state value and the update state confirmation value do not match.

Preferably, in the aforementioned method for detecting disk write omissions, the update state value comprises an update generation number, an update time, or a check code which is uniquely generated from the update data of the set of blocks, or a combination thereof.

The present invention also provides a method for detecting write omissions on a disk which stores electronic data as an object for processing in a computer. The method comprises relating a history block to a set of blocks, the history block being set an update state value indicating an update state, the set of blocks being set an update data as an object of reading and writing by the computer, making a set of management data to be an object of an update state check from the set of blocks and the history block, calculating a first update state value that is defined according to the update data in the set of management data when writing the update data on the disk, writing the set of management data including the update data and the first update state value on the disk, calculating a second update state value defined according to the update data in the set of management data read from the disk, setting the second update state value as an update state confirmation value, comparing the first update state value in the set of management data read from the disk with the update state confirmation value, and detecting that a disk write omission occurred when the first update value and the update state confirmation value do not match.

The present invention further provides a method for detecting write omissions on a plurality of disks which store electronic data as an object for processing in a computer. The method comprises relating a history block to a set of blocks, the history block being set an update state value indicating an update state, the set of blocks being set an update data as an object of reading and writing by the computer, making a set of management data to be an object of an update state check from the set of blocks and the history block, generating a new update state value which is different to an update state value before updating when writing the update data on the plurality of disks, writing the set of management data containing the update data and the new update state value on the plurality of disks redundantly, comparing the update state values in the set of management data which are read from each of the plurality of disks, and detecting that a disk write omission occurred when the update state values do not match each other.

Preferably, the aforementioned method for detecting disk write omissions further comprises, when a block which is not an object of updating is present between the history block and the blocks containing update data whose contents are changed in the current operation in the set of management data, reading data of the block which is not an object of updating from the disk and merging the read data with the data of the blocks containing the update data.

According to the present invention, a disk write omission can be accurately detected even when a disk write omission occurred in the entire area of the set of management data.

### BRIEF DESCRIPTION OF THE DRAWINGS

FIG. 1A is a diagram showing an update state confirmation value. FIG. 1B is a diagram showing an update data and an update state value.

FIG. 2 is a diagram showing one example of a system configuration diagram of the present invention.

FIG. 3 is a diagram showing another example of a system configuration of the present invention.

FIG. 4 is a diagram showing one example of a functional block diagram of the apparatus for detecting disk write omissions.

FIG. 5 is a diagram showing one example of the data configuration of an update state confirmation value management table.

FIG. 6 is a diagram illustrating the updating of data of blocks of one portion of N blocks.

FIG. 7 is a diagram showing an example of the flow of a write process.

FIG. 8 is a diagram showing an example of the flow of an update state check process.

FIG. 9 is a diagram showing an example of the flow of a write process.

FIG. 10 is a diagram showing an example of the flow of an update state check process.

FIG. 11 is a diagram showing an example of the flow of a write process.

FIG. 12 is a diagram showing an example of the flow of an update state check process.

FIG. 13A and FIG. 13B are diagrams illustrating the calculation of a new update state value.

FIG. 14 is a diagram showing an example of the flow of an update state check process.

FIG. 15 is a diagram showing one example of the data configuration of an update state value and an update state confirmation value.

FIG. 16 is a diagram showing an example of the flow of a write process.

FIG. 17 is a diagram showing an example of the flow of an update state check process.

FIG. 18 is a diagram showing an example of the flow of an update state check process.

FIG. 19 is a diagram showing an example of the format of one block.

### DETAILED DESCRIPTION OF THE PREFERRED EMBODIMENTS

In the present invention, to a set of blocks for setting update data, one history block in which to set an update state value indicating the update state of the set of blocks is related. A set of management data that is the object of an update state check is made from the set of blocks for setting update data and the history block for setting an update state value.

When writing update data on a disk, a new update state value is generated that is different to the update state value before the updating, and that new update state value is stored in a memory as an update state confirmation value. The update state confirmation value is data that is compared with the update state value when checking the update state.

The set of blocks in which update data was set and the one block in which the new update state value was set are then written together on the disk as the set of management data.

After writing the set of management data on the disk, an update state check is carried out. More specifically, the update state value in the set of management data is read from the disk and compared with the update state confirmation value recorded in the memory. When the update state confirmation value and the update state value do not match, it is judged that a disk write omission occurred.

As examples of the timing of the update state check, an extension of writing to the disk, an asynchronous patrol to the disk, a time of reading from the disk in accordance with a request of the host computer and the like may be mentioned.

According to the present invention, in addition to blocks in which update data is set, one block is allocated for an update state value to be written to the disk. This is because processing efficiency and storage efficiency are poor if all update data relating to a write request from the host computer is retained on the memory as an update state confirmation value as well as being retained on the disk as an update state value.

According to the present invention, in order to efficiently store an update state confirmation value and an update state value, one update state confirmation value and one update state value is set for a set of blocks in which update data is set.

The unit of the set of blocks in which update data is set may be, for example, a host I/O processing unit or a strip that conducts consecutive I/O to one disk in a RAID device.

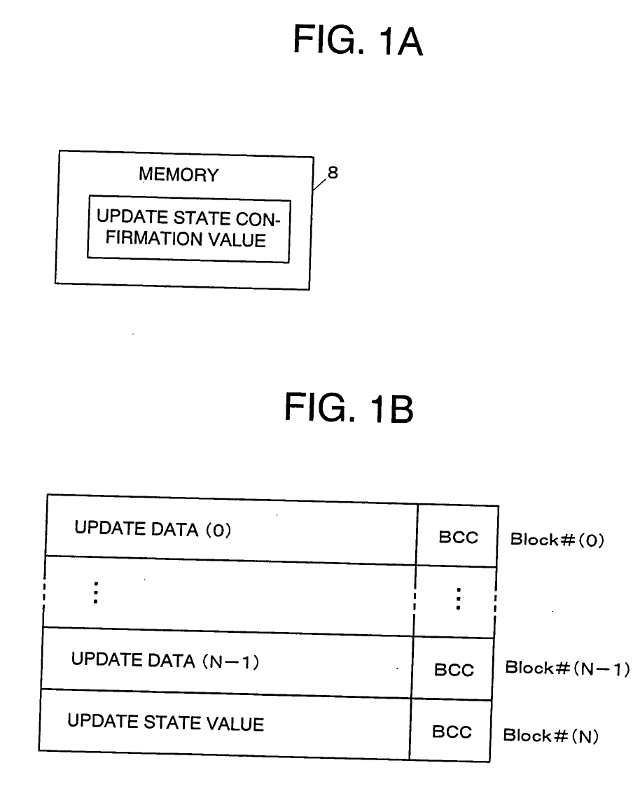

FIG. 1A is a diagram showing an update state confirmation value that is set on a memory. FIG. 1B is a diagram showing update data and update state values that are written on a disk. In FIG. 1B, the N blocks from block #(0) to block #(N−1) are blocks in which update data is set. Block #(N) is a block in which an update state value to be written on a disk is set.

In the present invention, as shown in FIG. 1A, an update state confirmation value is set on a memory 8. In the block #(N) shown in FIG. 1B, the update state confirmation value on the memory 8 is set as an update state value, and added to the blocks from block #(0) to #(N−1) in which update data was set.

The N+1 blocks from block #(0) to block #(N) are then written on a disk as a set of management data.

After writing the set of management data on the disk, the update state value is read from the disk and the read update state value is compared with the update state confirmation value that was set on the memory 8.

When the update state value and the update state confirmation value match, it is determined that the update data was written normally on the disk. When the update state value and the update state confirmation value do not match, it is determined that a disk write omission occurred.

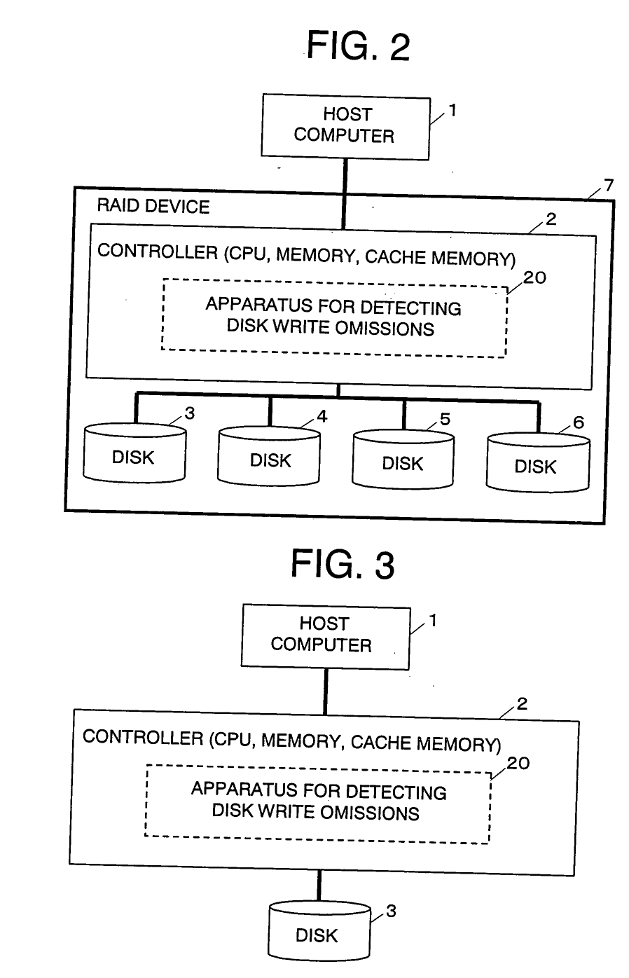

FIG. 2 is a diagram showing one example of a system configuration diagram of the present invention. In FIG. 2, reference numeral 1 denotes a host computer, reference numeral 2 denotes a controller, reference numerals 3 to 6 denote disks, and reference numeral 20 denotes an apparatus for detecting disk write omissions. The controller 2 writes or reads data to or from each disk in accordance with a write request or a read request from the host computer 1. The controller 2 is implemented by hardware such as a CPU, a memory, and a cache memory.

The apparatus for detecting disk write omissions 20 detects disk write omissions. In this system, the apparatus for detecting disk write omissions 20 is implemented by the controller 2. In addition to a function to detect disk write omissions, the apparatus for detecting disk write omissions 20 has the same disk control functions as a conventional apparatus, and comprises a RAID device 7 that redundantly writes update data on each disk.

The host computer 1 issues requests to read or write data from or to the disks 3 to 6 to the apparatus for detecting disk write omissions 20. After writing update data on the disks 3 to 6, the apparatus for detecting disk write omissions 20 checks that the update data was written normally.

FIG. 3 is a diagram showing another example of the system configuration of the present invention. In the system shown in FIG. 3, the apparatus for detecting disk write omissions 20 does not comprise a RAID device and is implemented as a controller 2 that writes update data to a single disk 3.

Both the system configuration shown in FIG. 2 and the system configuration shown in FIG. 3 can be employed for the present invention.

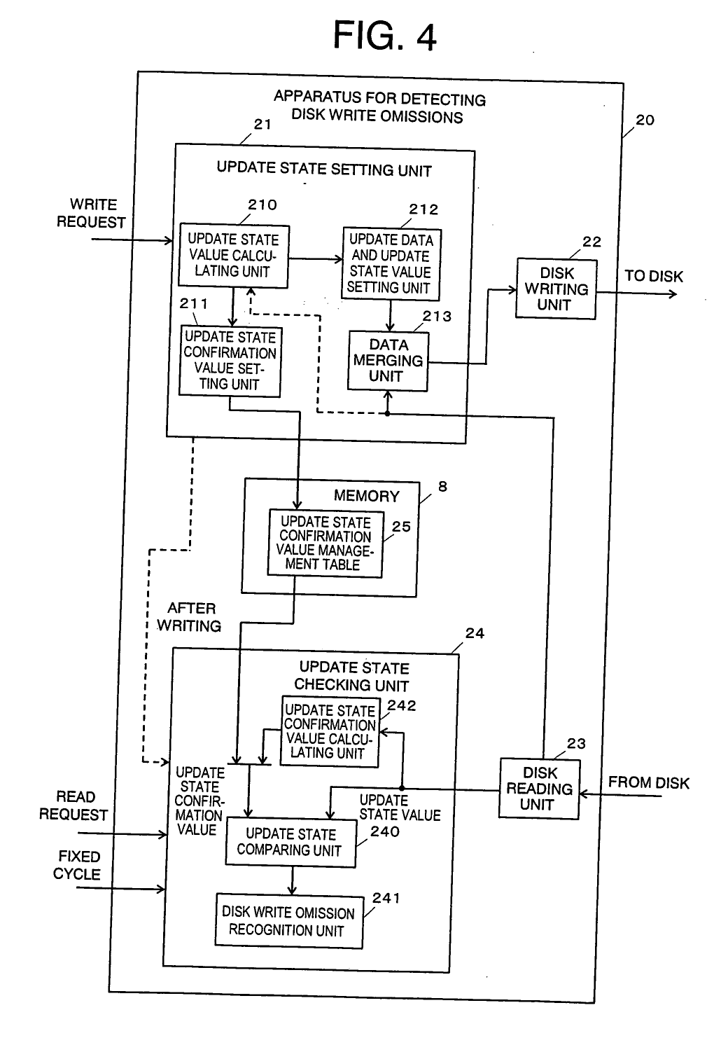

FIG. 4 is a diagram showing one example of a functional block diagram of the apparatus for detecting disk write omissions. The apparatus for detecting disk write omissions 20 comprises an update state setting unit 21, a disk writing unit 22, a disk reading unit 23, an update state checking unit 24, and a memory 8.

The update state setting unit 21 receives write requests from the host computer and sets update data and an update state value in a set of management data that is written onto a disk. The update state setting unit 21 also stores an update state confirmation value in a memory 8.

The disk writing unit 22 writes update data and an update state value that were set in the set of management data by the update state setting unit 21 onto a disk. The disk reading unit 23 reads data that was written on a disk.

After the set of management data is written onto a disk, the update state checking unit 24 compares the update state confirmation value with the update state value that was read from the disk to thereby detect a disk write omission.

The timing at which processing to detect a disk write omission is carried out is, for example, the time directly after an operation to write onto the disk, the time of a read request from the host computer 1 or a timing of a fixed cycle or the like.

The memory 8 comprises an update state confirmation value management table 25 in which update state confirmation values are stored. The structure of data in the update state confirmation value management table 25 is described later.

The update state setting unit 21 comprises an update state value calculating unit 210, an update state confirmation value setting unit 211, an update data and update state value setting unit 212 and a data merging unit 213. The update state value calculating unit 210 calculates update state values that are set in the set of management data. The update state confirmation value setting unit 211 stores the calculated update state values in the update state confirmation value management table 25 as update state confirmation values.

The update data and update state value setting unit 212 sets update data in the set of management data inside a buffer memory and also sets update state values that were calculated by the update state value calculating unit 210 in the set of management data. The data merging unit 213 merges data of blocks containing update data with data of blocks that are not objects of updating that were read from a disk.

The update state checking unit 24 comprises an update state comparing unit 240, a disk write omission recognition unit 241, and an update state confirmation value calculating unit 242. The update state comparing unit 240 compares an update state value read from a disk with an update state confirmation value that was stored in the update state confirmation value management table 25, or compares an update state value read from a disk with an update state confirmation value that was calculated by the update state confirmation value calculating unit 242.

The disk write omission recognition unit 241 recognizes whether or not a disk write omission occurred based on a comparison result produced by the update state comparing unit 240. The update state confirmation value calculating unit 242 calculates an update state confirmation value based on data read from a disk.

In this connection, when the apparatus for detecting disk write omissions 20 comprises a RAID device and redundantly writes the set of management data in which update data and update state values were set onto a plurality of disks, the update state comparing unit 240 compares the update state values that were respectively read from the plurality of disks. In this case, processing by the update state confirmation value setting unit 211 to store update state confirmation values in the update state confirmation value management table 25 is not required.

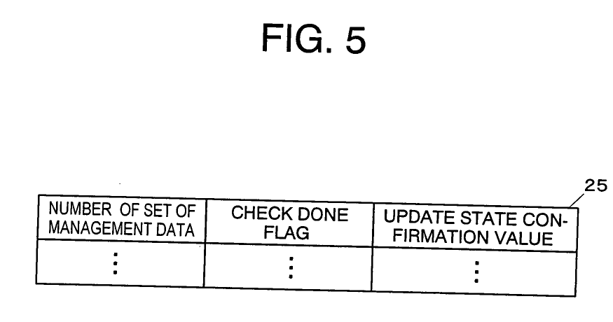

FIG. 5 is a diagram showing one example of the configuration of data of an update state confirmation value management table. The update state confirmation value management table 25 is composed of a region in which a number of each set of management data are set, a region in which a check done flag is set, and a region in which an update state confirmation value is set. A number of a set of management data is a number that uniquely identifies the set of management data. A check done flag is a flag that shows whether or not the update state checking unit 24 has checked an update state value of the set of management data that was written on a disk. The check done flag is not required when the update state checking unit 24 checks the update state value of the set of management data each time the set of management data is written.

In this connection, according to the present invention, the update state confirmation value management table 25 is not required in a case in which, before a process to write the set of management data on a disk, an update state value is read from the disk and the read update state value is then incremented and employed as an update state confirmation value.

Embodiments of the present invention are described hereunder. In an embodiment 1 to an embodiment 5 below, the apparatus for detecting disk write omissions 20 is configured to write a set of management data on one disk. In an embodiment 6, the apparatus for detecting disk write omissions 20 comprises a RAID device and is configured to redundantly write a set of management data on a plurality of disks.

Hereunder, the embodiment 1 of the present invention is described. In the embodiment 1, update generation numbers that indicate the update generation of data are used as update state values and update state confirmation values. Each time a set of management data of N+1 blocks is written to a disk an update generation number is incremented by the update state setting unit 21.

The update state checking unit 24 compares an update state confirmation value that was stored in the update state confirmation value management table 25 with an update state value that was read from a disk, and if the values do not match the update state checking unit 24 determines that a disk write omission occurred.

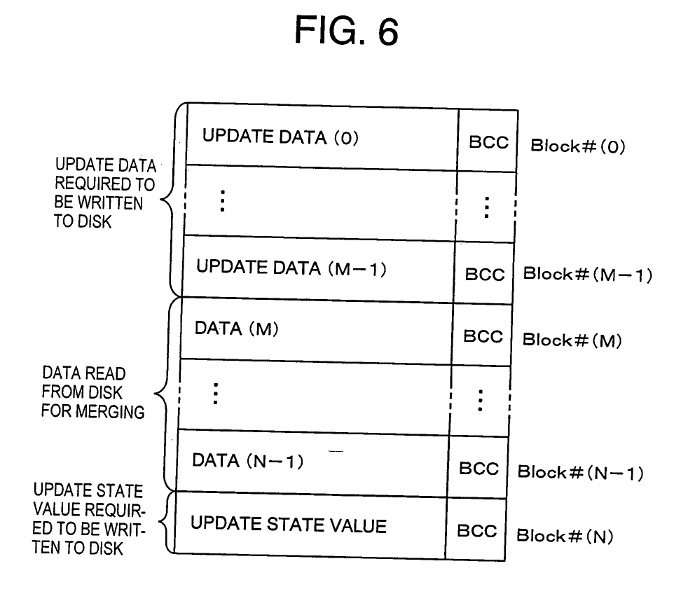

Here, as shown in FIG. 6, it is assumed, for example, that of the N blocks from Block# (0) to Block# (N−1), the update data to be written to the disk is in the M blocks from Block# (0) in which update data (0) is set to Block# (M−1) in which update data (M−1) is set. Further, the blocks from Block# (M) to Block# (N−1) are blocks in which data (M) to data (N−1) are set as data that is not an object of updating.

Thus, in a case in which blocks in which update data is set constitute one portion of N blocks, the blocks in which update data is set are separated from a block (Block #(N)) in which an update state value is set. Since it is considered that a disk write omission occurs in one write operation, it is necessary that writing onto the disk of the blocks in which update data is set and the block in which the update state value is set be carried out in one write operation.

Therefore, in the embodiment 1, the disk reading unit 23 reads from the disk the blocks from Block# (M) to Block# (N−1) that are not an object of updating. Then, the data merging unit 213 of the update state setting unit 21 merges the data of the blocks containing update data with the data of the blocks that are not an object of updating that were read from the disk. The update data and update state value setting unit 212 sets the blocks from Block# (0) to Block# (N) after merge processing by the data merging unit 213 in a set of management data to be written onto the disk.

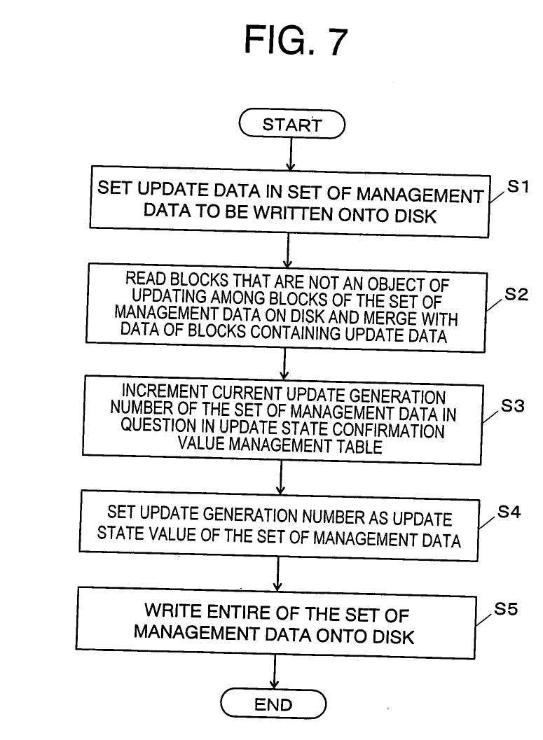

FIG. 7 shows one example of the flow of a write process in the embodiment 1. First, the update data and update state value setting unit 212 sets update data in a set of management data to be written onto a disk (step S1).

Next, the disk reading unit 23 reads blocks that are not an object of updating among the blocks of the set of management data on the disk and merges these blocks with the data of the blocks containing the update data (step S2).

The update state confirmation value setting unit 211 then increments the current update generation number of the set of management data in question in the update state confirmation value management table 25 (step S3). The update data and update state value setting unit 212 sets the update generation number as the update state value of the set of management data (step S4). Then, the disk writing unit 22 writes the entire of the set of management data onto the disk (step S5).

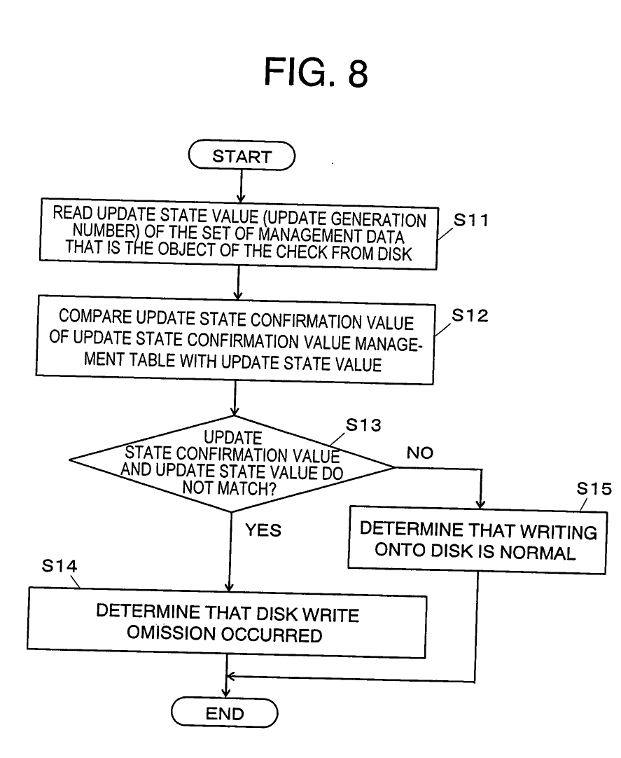

FIG. 8 is a diagram showing one example of the flow of an update state check process in the embodiment 1. First, the disk reading unit 23 reads the update state value (update generation number) of the set of management data that is the object of the check from the disk (step S11). Then, the update state comparing unit 240 of the update state checking unit 24 compares the update state confirmation value of the update state confirmation value management table 25 with the update state value (step S12). When the update state confirmation value and the update state value do not match (step S13), the disk write omission recognition unit 241 determines that a disk write omission occurred (step S14). When the update state confirmation value and the update state value match, the disk write omission recognition unit 241 determines that the writing onto the disk is normal (step S15).

Hereunder, an embodiment 2 of the present invention is described. The difference between the embodiment 2 and the embodiment 1 is that in the embodiment 2 the time of updating data is used as the update state value and the update state confirmation value.

For the embodiment 2, it is necessary to deal with cases in which a plurality of operations to write to a disk is performed at the same time. Therefore, in this case, for example, an update state check is performed prior to write operations performed at the same time and scheduling is carried out so that write operations are not carried out to the same region at the same time.

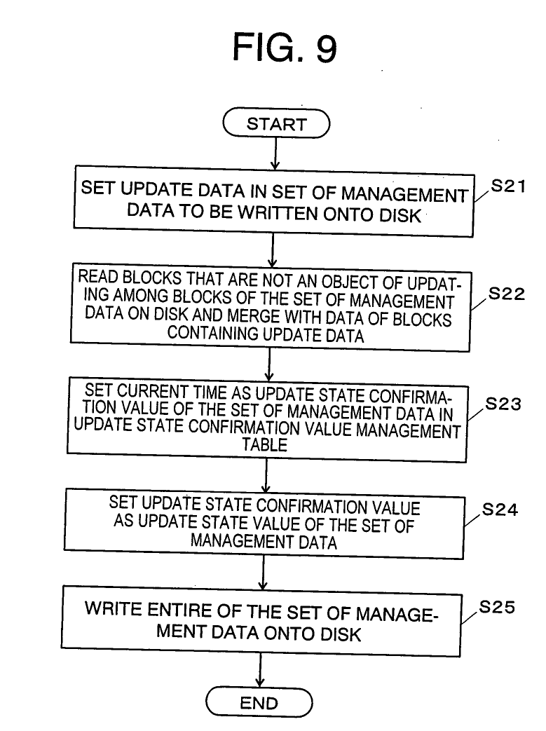

FIG. 9 is a diagram showing an example of the flow of a write process in the embodiment 2. First, the update data and update state value setting unit 212 sets update data in a set of management data to be written onto a disk (step S21).

Next, the disk reading unit 23 reads the blocks that are not an object of updating among the blocks of the set of management data on the disk and merges these blocks with the data of the blocks containing update data (step S22).

The update state confirmation value setting unit 211 then sets the current time as the update state confirmation value of the set of management data in the update state confirmation value management table 25 (step S23). The update data and update state value setting unit 212 sets the update state confirmation value as the update state value of the set of management data (step S24). Then, the disk writing unit 22 writes the entire of the set of management data onto the disk (step S25).

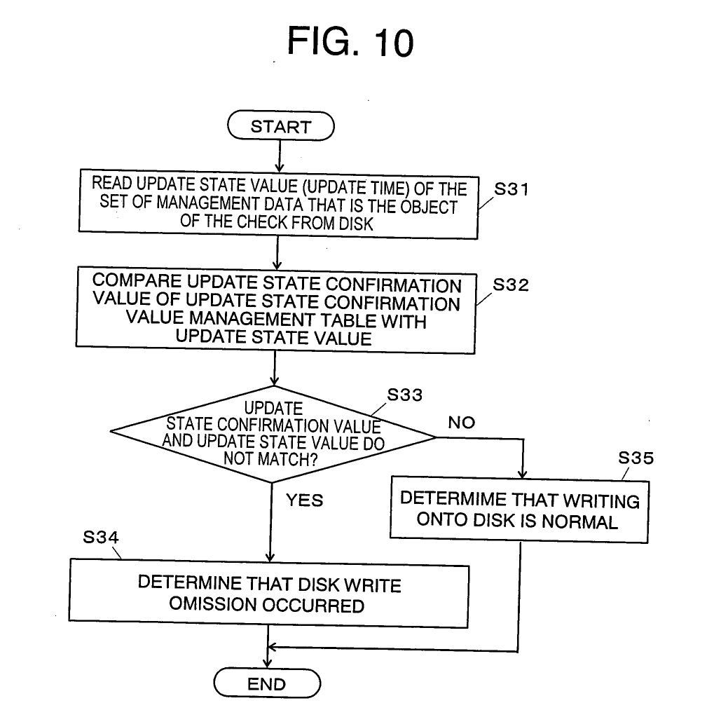

FIG. 10 is a diagram showing an example of the flow of an update state check process in the embodiment 2. First, the disk reading unit 23 reads the update state value (update time) of the set of management data that is the object of the check from the disk (step S31). Then, the update state comparing unit 240 of the update state checking unit 24 compares the update state confirmation value of the update state confirmation value management table 25 with the update state value (step S32). When the update state confirmation value and the update state value do not match (step S33), the disk write omission recognition unit 241 determines that a disk write omission occurred (step S34). When the update state confirmation value and the update state value match, the disk write omission recognition unit 241 determines that the writing onto the disk is normal (step S35).

Hereunder, an embodiment 3 of the present invention is described. In the embodiment 3, the update state value calculating unit 210 of the update state setting unit 21 carries out calculation processing using CRC or XOR (exclusive disjunction) for a data part (blocks in which update data and merged data not an object of updating are assigned) of a set of management data to generate a check code.

The update state confirmation value setting unit 211 sets the generated check code in the update state confirmation value management table 25 as the update state confirmation value, and the update data and update state value setting unit 212 sets the check code as the update state value of the set of management data.

The disk writing unit 22 writes update data and the update state value onto a disk, then the disk reading unit 23 reads the update state value from the disk.

The update state comparing unit 240 of the update state checking unit 24 compares the read update state value with the update state confirmation value in the update state confirmation value management table 25. If the update state value and the update state confirmation value do not match, the disk write omission recognition unit 241 determines that a disk write omission occurred.

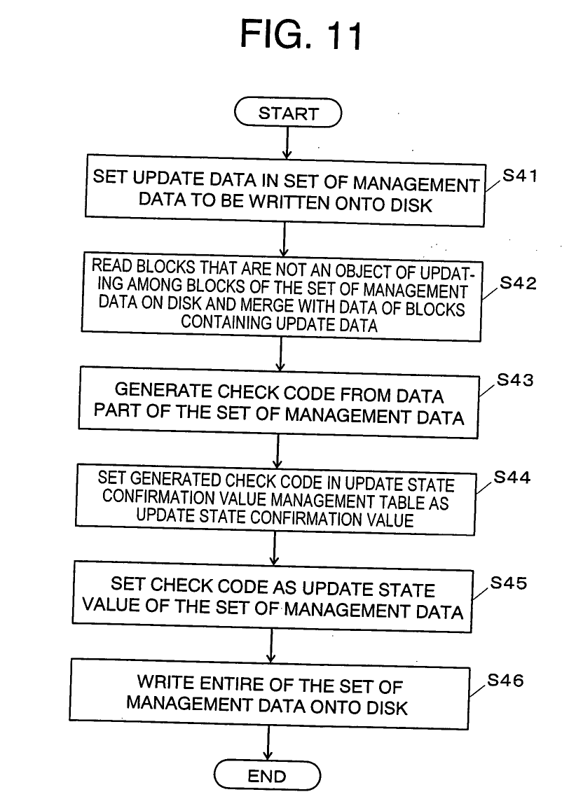

FIG. 11 shows one example of the flow of a write process in the embodiment 3. First, the update data and update state value setting unit 212 sets update data in a set of management data to be written onto a disk (step S41).

Next, the disk reading unit 23 reads the blocks that are not an object of updating among the blocks of the set of management data on the disk and merges these blocks with the data of blocks containing the update data (step S42).

The update state value calculating unit 210 generates a check code from the data part of the set of management data (step S43). Then, the update state confirmation value setting unit 211 sets the generated check code in the update state confirmation value management table 25 as an update state confirmation value (step S44).

Next, the update data and update state value setting unit 212 sets the check code as the update state value of the set of management data (step S45). Then, the disk writing unit 22 writes the entire of the set of management data onto the disk (step S46).

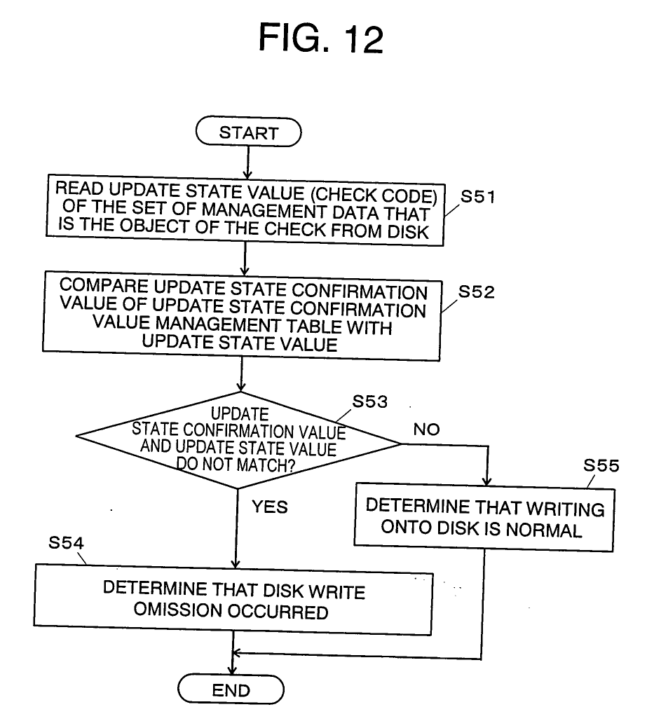

FIG. 12 is a diagram showing an example of the flow of an update state check process in the embodiment 3. First, the disk reading unit 23 reads the update state value (check code) of the set of management data that is the object of the check from the disk (step S51). Then, the update state comparing unit 240 of the update state checking unit 24 compares the update state confirmation value of the update state confirmation value management table 25 with the update state value (step S52). When the update state confirmation value and the update state value do not match (step S53), the disk write omission recognition unit 241 determines that a disk write omission occurred (step S54). When the update state confirmation value and the update state value match, the disk write omission recognition unit 241 determines that the writing onto the disk is normal (step S55).

Hereunder, an embodiment 4 of the present invention is described. In the embodiment 4, the update state value calculating unit 210 of the update state setting unit 21 implements processing using CRC or XOR (exclusive disjunction) for a data part (blocks in which update data and merged data that is not an object of updating are assigned) of a set of management data to generate a check code.

The update data and update state value setting unit 212 then sets the generated check code as the update state value of the set of management data.

After the set of management data is written onto a disk, the disk reading unit 23 reads the update data and the update state value of the set of management data from the disk. The update state confirmation value calculating unit 242 of the update state checking unit 24 carries out calculation processing using CRC or XOR (exclusive disjunction) for the update data that was read, and generates a check code to be used as the update state confirmation value.

The update state comparing unit 240 then compares the update state value that was read and the generated check code. If the update state value and the check code do not match, the disk write omission recognition unit 241 determines that a disk write omission occurred.

In the embodiment 4, a check for disk write omissions is conducted on the basis of the result of comparing an update state value read from a disk with a check code generated using update data read from the disk. Accordingly, unlike the embodiment 3, processing to set an update state confirmation value in the update state confirmation value management table 25 can be omitted.

In the embodiment 4, when blocks in which update data is set comprise one portion of N blocks, similarly to the embodiment 1, a technique can be adopted that merges blocks containing data not an object to updating that were read from a disk with blocks containing update data.

Further, in the embodiment 4, even in a case in which blocks of update data comprise one portion of N blocks, as described below, for example, an XOR operation can be performed on the “update data” as well as the “existing data” corresponding to the update data and “existing update state value” to calculate a new update state value after updating.

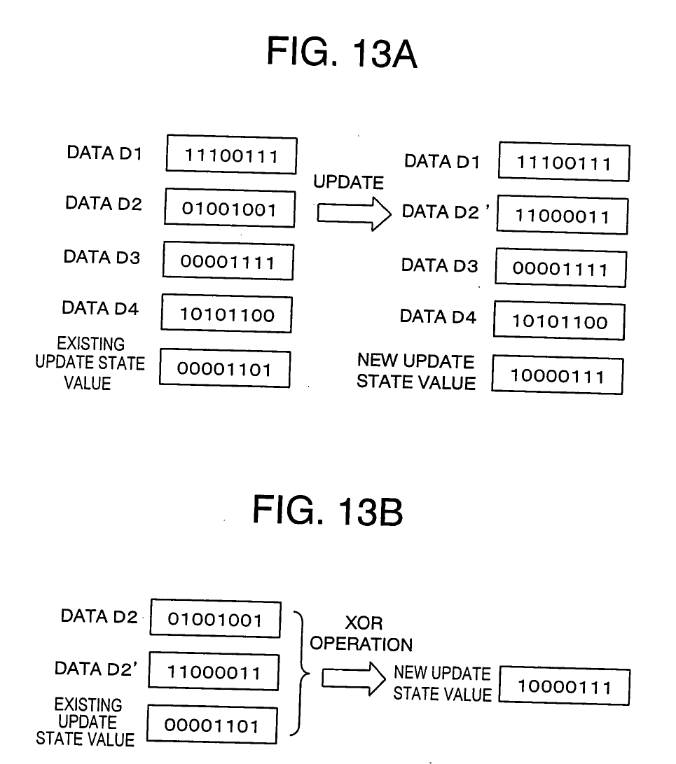

The figure on the left side of FIG. 13A shows an example of existing data and an existing update state value on a disk. The figure on the right side of FIG. 13A shows an example of data and a new update state value after updating. To facilitate ease of explanation in this example, each data and update state value is represented in 8 bits.

As shown in the figure on the left side of FIG. 13A, among the existing data from data D1 to data D4, for example, it is taken that the data D1 is “11100111”, the data D2 is “01001001”, the data D3 is “00001111” and the data D4 is “10101100”.

The existing update state value “00001101” is the result obtained by executing an XOR operation on data units for the data D1 to data D4.

In this case, as shown in the figure on the right side of FIG. 13A, the data D2 is updated to data D2′ “11000011”. The new update state value “10000111” shown in the figure on the right side of FIG. 13A is the result obtained by performing an XOR operation on data units for the data D2′ and the existing data (data D1, data D3, data D4).

In the embodiment 4 of the present invention, a new update state value can be calculated without performing an XOR operation on all of the existing data and the update data. For example, as shown in FIG. 13B, by performing an XOR operation on data units for the data D2′“11000011” that is the update data as well as the data D2 “01001001” that is the existing data corresponding to the data D2′ and the existing update state value “00001101”, a new update state value “10000111” can be calculated that is the same as the result obtained by performing an XOR operation on all of data D1, D2′, D3 and D4.

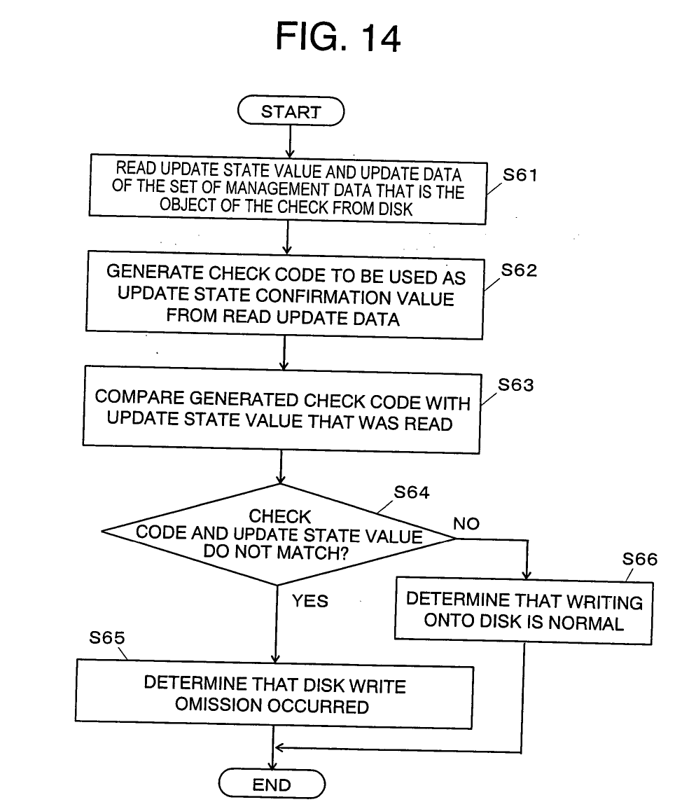

FIG. 14 is a diagram showing an example of the flow of an update state check process in the embodiment 4. First, the disk reading unit 23 reads the update state value and the update data of the set of management data that is the object of the check from the disk (step S61). The update state confirmation value calculating unit 242 of the update state checking unit 24 generates a check code to be used as the update state confirmation value from the read update data (step S62).

The update state comparing unit 240 then compares the generated check code with the update state value that was read (step S63). When the check code and the update state value do not match (step S64), the disk write omission recognition unit 241 determines that a disk write omission occurred (step S65). When the check code and the update state value match, the disk write omission recognition unit 241 determines that the writing onto the disk is normal (step S66).

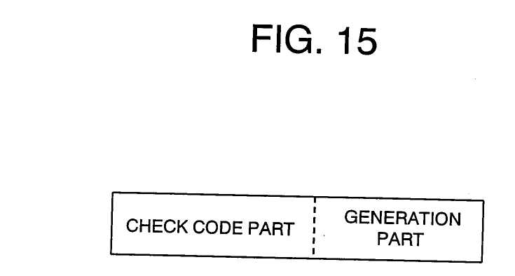

Hereunder, the embodiment 5 of the present invention is described. FIG. 15 is a diagram showing one example of the data configuration of an update state value and an update state confirmation value. As shown in FIG. 15, in the embodiment 5 an update state value and an update state confirmation value are composed of a check code part and a generation part. Of this update state confirmation value, the generation part is set in the update state confirmation value management table 25 and the check code part is generated from update data each time an update occurs.

In the embodiment 5, the update state value calculating unit 210 implements processing using CRC or XOR (exclusive disjunction) for a data part of a set of management data to generate a check code. The update state confirmation value setting unit 211 sets an update generation number in the generation part of an update state confirmation value of the update state confirmation value management table 25. In the embodiment 5, the time data is updated may be set in the generation part of the update state confirmation value in place of the update generation number.

As the update state value of the set of management data, the update data and update state value setting unit 212 sets the update generation number set in the generation part of the update state confirmation value in the generation part thereof, and sets the check code generated by the update state value calculating unit 210 in the check code part thereof, inside a buffer memory.

After writing the set of management data to a disk, the update state confirmation value calculating unit 242 generates a check code based on update data that was read from the disk.

The update state comparing unit 240 compares the check code part of the update state value that was read from the disk with the check code that was generated by the update state confirmation value calculating unit 242. When the check code part of the update state value and the check code that was generated by the update state confirmation value calculating unit 242 do not match, the disk write omission recognition unit 241 determines that a disk write omission occurred.

Further, the update state comparing unit 240 compares the generation part of the update state value that was read from the disk with the generation part of the update state confirmation value of the update state confirmation value management table 25. When the generation part of the update state value and the generation part of the update state confirmation value of the update state confirmation value management table 25 do not match, the disk write omission recognition unit 241 determines that a disk write omission occurred.

In the embodiment 5, a disk write omission is detected based on the result of comparing a check code part of an update state value that was read from a disk with a check code generated by the update state confirmation value calculating unit 242. Thus, according to the embodiment 5, a writing omission that occurred in one part of the set of management data can be detected.

Further, in the embodiment 5 a disk write omission is detected based on the result of comparing a generation part of an update state value that was read from a disk with a generation part of an update state confirmation value of the update state confirmation value management table 25. Thus, according to the embodiment 5, a writing omission that occurred in the entire area of the set of management data can also be detected.

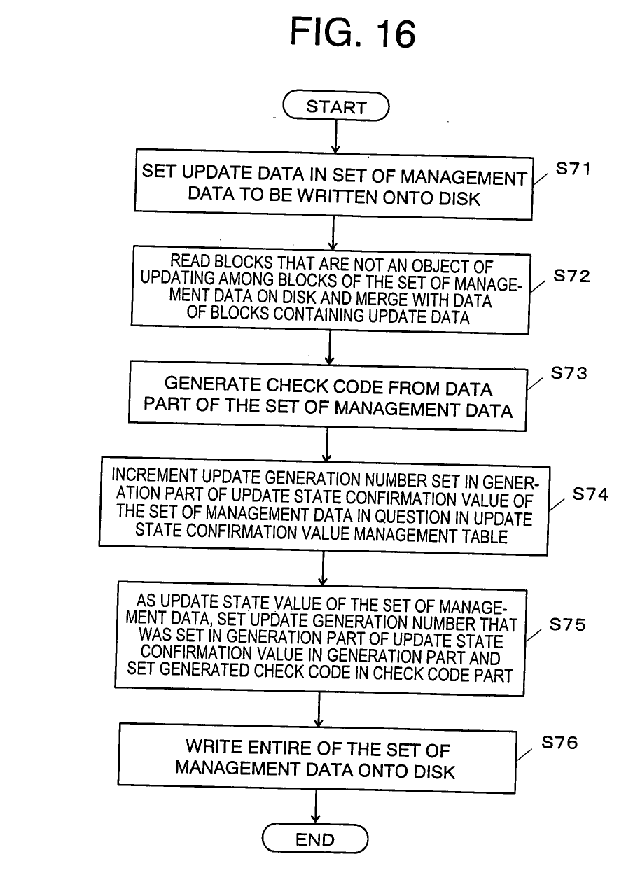

FIG. 16 is a diagram showing one example of the flow of a write process in the embodiment 5. First, the update data and update state value setting unit 212 sets update data in a set of management data to be written onto a disk (step S71).

Next, the disk reading unit 23 reads blocks that are not an object of updating among blocks of the set of management data on the disk and merges these blocks with the data of blocks containing update data (step S72).

The update state value calculating unit 210 then generates a check code from the data part of the set of management data (step S73).

Next, the update state confirmation value setting unit 211 increments the update generation number that was set in the generation part of the update state confirmation value of the set of management data in question in the update state confirmation value management table 25 (step S74). In this connection, in step S74, it is also possible to set the current time in the generation part of the update state confirmation value.

As the update state value of the set of management data, the update data and update state value setting unit 212 sets the update generation number that was set in the generation part of the update state confirmation value in the generation part thereof, and sets the generated check code in the check code part thereof (step S75). Then, the disk writing unit 22 writes the entire of the set of management data onto the disk (step S76).

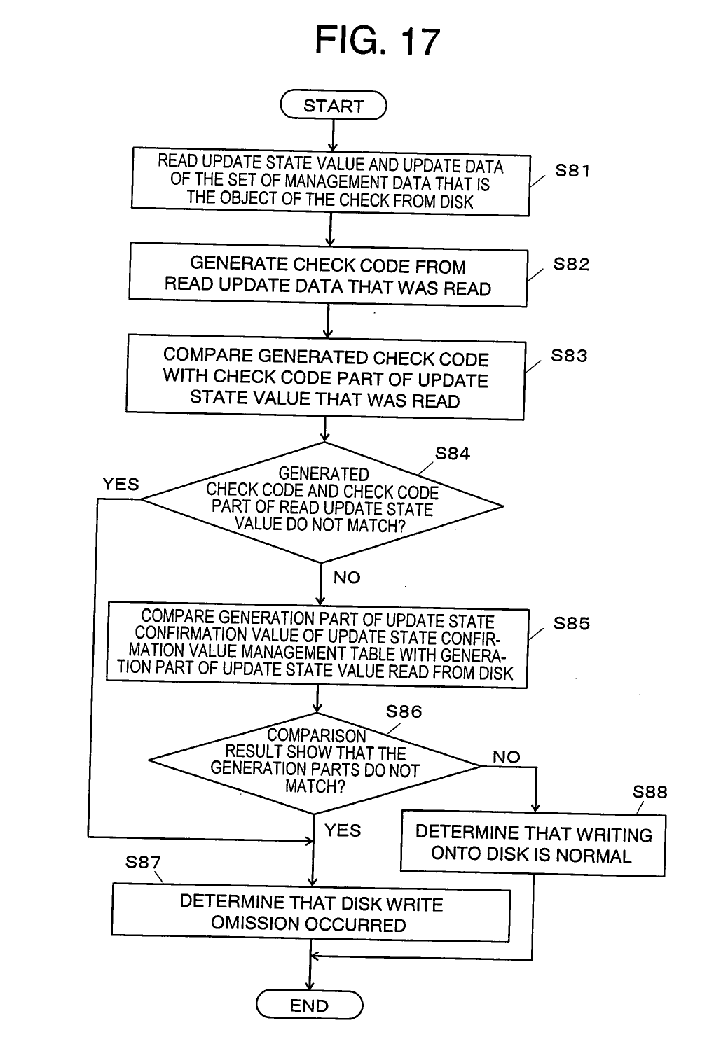

FIG. 17 is a diagram showing an example of the flow of an update state check process in the embodiment 5. First, the disk reading unit 23 reads the update state value and the update data of the set of management data that is the object of the check from the disk (step S81). Then, the update state confirmation value calculating unit 242 of the update state checking unit 24 generates a check code based on the update data that was read (step S82).

The update state comparing unit 240 compares the generated check code with the check code part of the update state value that was read (step S83). When the generated check code and the check code part of the update state value that was read do not match (step S84), the disk write omission recognition unit 241 determines that a disk write omission occurred (step S87).

When the generated check code matches the check code part of the update state value that was read, the update state comparing unit 240 compares the generation part of the update state confirmation value of the update state confirmation value management table 25 with the generation part of the update state value that was read from the disk (step S85). When the comparison result shows that the generation parts do not match (step S86), the disk write omission recognition unit 241 determines that a disk write omission occurred (step S87). When the comparison result shows that the generation parts match, the disk write omission recognition unit 241 determines that the writing onto the disk is normal (step S88).

Hereunder, the embodiment 6 of the present invention is described. In the embodiment 6, unlike the embodiment 1, the apparatus for detecting disk write omissions 20 comprises a RAID device and redundantly writes a set of management data on a plurality of disks.

In the case of RAID in which an update state value is written redundantly on a plurality of disks, the possibility of a writing omission occurring in a similar manner at the same time on a plurality of disks is low, irrespective of mirror/parity.

Therefore, in the embodiment 6 the update state comparing unit 240 compares update state values, more specifically, update generation numbers, that are read from a plurality of disks, respectively. When the update generation numbers that are read respectively from the plurality of disks are the same, the disk write omission recognition unit 241 determines that writing was conducted normally on the plurality of disks. When the update generation numbers that are read respectively from the plurality of disks differ, the disk write omission recognition unit 241 determines that a disk write omission occurred on the disk in which the update generation number is that of an old generation.

In the embodiment 6, since disk write omissions are detected based on the result of comparing update generation numbers that are read from a plurality of disks, respectively, processing to set an update state confirmation value in the update state confirmation value management table 25 can be omitted.

The flow of a write process conducted when writing to each disk is the same as that illustrated in FIG. 7, and a description thereof using a flowchart is thus omitted here.

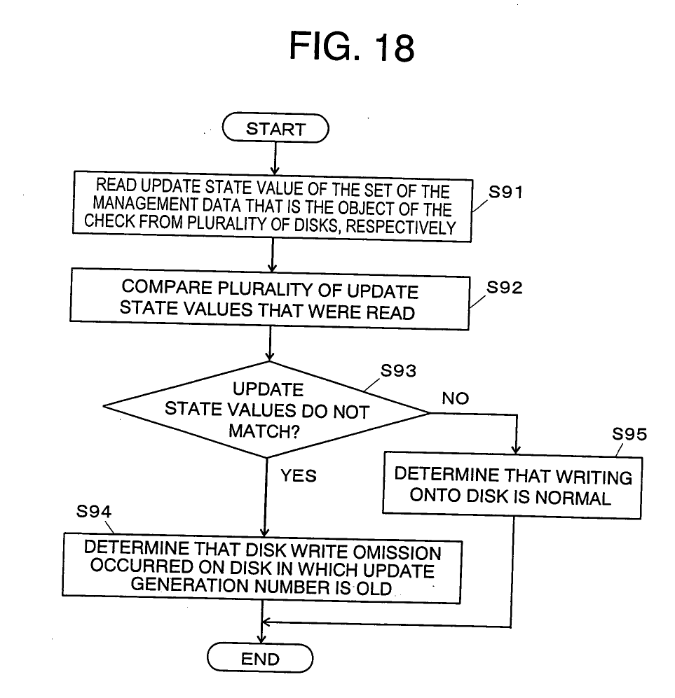

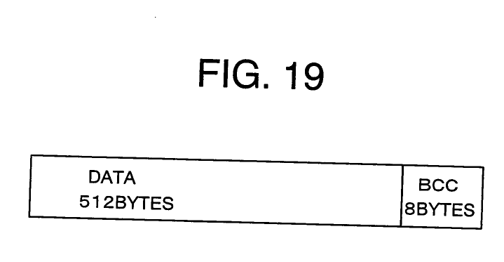

FIG. 18 is a diagram showing one example of the flow of an update state check process in the embodiment 6 of the present invention. First, the disk reading unit 23 reads the update state value of the set of management data that is the object of the check from a plurality of disks, respectively (step S91).

Next, the update state comparing unit 240 of the update state checking unit 24 compares the plurality of update state values that were read (step S92). When the update state values do not match (step S93), the disk write omission recognition unit 241 determines that a disk write omission occurred on the disk in which the update generation number is old (step S94). When the update state values match, the disk write omission recognition unit 241 determines that writing onto the disks was conducted normally (step S95).

In the embodiment 6, similarly to the embodiment 2 and the embodiment 3, instead of using an update generation number as the update state value, a data update time or a check code or the like may be used.

In this connection, the present invention can also be implemented as a program that is read and executed by a computer. A program implementing the present invention can be stored on an appropriate computer-readable storage medium such as a portable medium memory, a semiconductor memory or a hard disk, and provided by storing the program on these storage media or by transmission and reception through a communications interface utilizing a network.

What is claimed is:

1. An apparatus for detecting write omissions on a disk which stores electronic data as an object for processing in a computer, the apparatus comprising:
an update state setting unit relating a history block to a set of blocks, the history block being set an update state value indicating an update state, the set of blocks being set an update data as an object of reading and writing by the computer, making a set of management data to be an object of an update state check from the set of blocks and the history block, generating a new update state value which is different to an update state value before updating when writing the update data on the disk, storing the new update state value in a memory as an update state confirmation value, writing the set of management data containing the update data and the new update state value on the disk; and
an update state checking unit comparing the update state value in the set of management data read from the disk with the update state confirmation value which is stored in the memory, and detecting that a disk write omission occurred when the update state value and the update state confirmation value do not match.

2. The apparatus according to claim 1, wherein the update state value comprises an update generation number, an update time, or a check code which is uniquely generated from the update data of the set of blocks, or a combination thereof.

3. An apparatus for detecting write omissions on a disk which stores electronic data as an object for processing in a computer, the apparatus comprising:
an update state setting unit relating a history block to a set of blocks, the history block being set an update state value indicating an update state, the set of blocks being set an update data as an object of reading and writing by the computer, making a set of management data to be an object of an update state check from the set of blocks and the history block, calculating a first update state value that is defined according to the update data in the set of management data when writing the update data on the disk, writing the set of management data including the update data and the first update state value on the disk; and
an update state checking unit calculating a second update state value defined according to the update data in the set of management data read from the disk, setting the second update state value as an update state confirmation value, comparing the first update state value in the set of management data read from the disk with the update state confirmation value, and detecting that a disk write omission occurred when the first update value and the update state confirmation value do not match.

4. An apparatus for detecting write omissions on a plurality of disks which store electronic data as an object for processing in a computer, the apparatus comprising:
an update state setting unit relating a history block to a set of blocks, the history block being set an update state value indicating an update state, the set of blocks being set an update data as an object of reading and writing by the computer, making a set of management data to be an object of an update state check from the set of blocks and the history block, generating a new update state value which is different to an update state value before updating when writing the update data on the plurality of disks, and writing the set of management data containing the update data and the new update state value on the plurality of disks redundantly; and
an update state checking unit comparing the update state values in the set of management data which are read from each of the plurality of disks, and detecting that a disk write omission occurred when the update state values do not match each other.

5. The apparatus for detecting according to claim 1, wherein the update state setting unit further comprises a data merging unit, when a block which is not an object of updating is present between the history block and the blocks containing update data whose contents are changed in the current operation in the set of management data, the data merging unit reads data of the block which is not an object of updating from the disk and merges the read data with the data of the blocks containing the update data.

6. The apparatus for detecting according to claim 2, wherein the update state setting unit further comprises a data merging unit, when a block which is not an object of updating is present between the history block and the blocks containing update data whose contents are changed in the current operation in the set of management data, the data merging unit reads data of the block which is not an object of updating from the disk and merges the read data with the data of the blocks containing the update data.

7. The apparatus for detecting according to claim 3, wherein the update state setting unit further comprises a data merging unit, when a block which is not an object of updating is present between the history block and the blocks containing update data whose contents are changed in the current operation in the set of management data, the data merging unit reads data of the block which is not an object of updating from the disk and merges the read data with the data of the blocks containing the update data.

8. The apparatus for detecting according to claim 4, wherein the update state setting unit further comprises a data merging unit, when a block which is not an object of updating is present between the history block and the blocks containing update data whose contents are changed in the current operation in the set of management data, the data merging unit reads data of the block which is not an object of updating from the disk and merges the read data with the data of the blocks containing the update data.

9. A method for detecting write omissions on a disk which stores electronic data as an object for processing in a computer, the method comprising:
relating a history block to a set of blocks, the history block being set an update state value indicating an update state, the set of blocks being set an update data as an object of reading and writing by the computer;
making a set of management data to be an object of an update state check from the set of blocks and the history block;
generating a new update state value which is different to an update state value before updating when writing the update data on the disk;
storing the new update state value in a memory as an update state confirmation value;
writing the set of management data containing the update data and the new update state value on the disk;
comparing the update state value in the set of management data read from the disk with the update state confirmation value which is stored in the memory; and
detecting that a disk write omission occurred when the update state value and the update state confirmation value do not match.

10. The method according to claim 9, wherein the update state value comprises an update generation number, an update time, or a check code which is uniquely generated from the update data of the set of blocks, or a combination thereof.

11. A method for detecting write omissions on a disk which stores electronic data as an object for processing in a computer, the method comprising:
relating a history block to a set of blocks, the history block being set an update state value indicating an update state, the set of blocks being set an update data as an object of reading and writing by the computer;
making a set of management data to be an object of an update state check from the set of blocks and the history block;
calculating a first update state value that is defined according to the update data in the set of management data when writing the update data on the disk;
writing the set of management data including the update data and the first update state value on the disk;
calculating a second update state value defined according to the update data in the set of management data read from the disk;
setting the second update state value as an update state confirmation value;
comparing the first update state value in the set of management data read from the disk with the update state confirmation value; and
detecting that a disk write omission occurred when the first update value and the update state confirmation value do not match.

12. A method for detecting write omissions on a plurality of disks which store electronic data as an object for processing in a computer, the method comprising:
relating a history block to a set of blocks, the history block being set an update state value indicating an update state, the set of blocks being set an update data as an object of reading and writing by the computer;
making a set of management data to be an object of an update state check from the set of blocks and the history block;
generating a new update state value which is different to an update state value before updating when writing the update data on the plurality of disks;
writing the set of management data containing the update data and the new update state value on the plurality of disks redundantly;
comparing the update state values in the set of management data which are read from each of the plurality of disks; and
detecting that a disk write omission occurred when the update state values do not match each other.

13. The method according to claim 9, the method further comprising:
when a block which is not an object of updating is present between the history block and the blocks containing update data whose contents are changed in the current operation in the set of management data, reading data of the block which is not an object of updating from the disk and merging the read data with the data of the blocks containing the update data.

14. The method according to claim 10, the method further comprising:
when a block which is not an object of updating is present between the history block and the blocks containing update data whose contents are changed in the current operation in the set of management data, reading data of the block which is not an object of updating from the disk and merging the read data with the data of the blocks containing the update data.

15. The method according to claim 11, the method further comprising:
when a block which is not an object of updating is present between the history block and the blocks containing update data whose contents are changed in the current operation in the set of management data, reading data of the block which is not an object of updating from the disk and merging the read data with the data of the blocks containing the update data.

16. The method according to claim 12, the method further comprising:
when a block which is not an object of updating is present between the history block and the blocks containing update data whose contents are changed in the current operation in the set of management data, reading data of the block which is not an object of updating from the disk and merging the read data with the data of the blocks containing the update data.
